(19) United States
(12) Patent Application Publication
(10) Pub. No.: US 2003/0221160 A1
(43) Pub. Date: Nov. 27, 2003

(54) Determination of a semantic snapshot

(76) Inventor: Robertus Cornelis Willibrordus Theodorus Maria Van Den Tillaart, (US)

Correspondence Address: BIRCH STEWART KOLASCH & BIRCH, PO BOX 747, FALLS CHURCH, VA, 22040-0747, US

(21) Appl. No.: 10/443,229

(22) Filed: May 22, 2003

(30) Foreign Application Priority Data
May 24, 2002 (NL) 1020670

(51) Int. Cl. G06F 17/00

(52) U.S. Cl. 715/500

(57) ABSTRACT

A method and apparatus for characterizing a document are described, particularly for the recognition, organization or relating of documents, for which purpose a series of statistical properties of the text in the document is determined. A list of words occurring in the document is determined and a frequency of occurrence is determined for each word in the list. The series is then built up of pairs respectively of one word from the list and the frequency of that word, where the series forms a semantic snapshot of the document. The semantic snapshot is used for comparing documents with one another or for comparing with a semantic snapshot of a specific area of attention or subject, so that the relevance of the document to that subject is determined.

This non-provisional application claims, under 35 U.S.C. §119, the priority benefit of Patent Application No. 1020670 filed in The Netherlands on May 24, 2002, the entire contents of which are herein incorporated by reference.

### BACKGROUND OF THE INVENTION

1. Field of the Invention

The invention relates to a method of characterizing a document, particularly for the recognition, organization or relating of documents, wherein a series of statistical properties of the text in the document is determined. The invention also relates to a computer program product for characterizing a document, and to a data signal. The invention also relates to an apparatus for processing documents, which apparatus comprises a module for characterizing a document by using a series of statistical properties of the text of the document, particularly for the recognition, organization or relating of documents.

2. Discussion of the Background Art

U.S. Pat. No. 5,418,951 is directed to a method of identifying, retrieving or sorting documents by language or subject. To this end, a series of n-grams is determined for each document, an n-gram being a combination of n letters or spaces. The frequency of each n-gram, i.e., how often the n-gram occurs in the document, is determined. The series of n-grams and frequencies are processed further by standardizing the frequency and removing a common component. On the basis of the series of n-grams, the language is determined in which the document was (probably) written, by comparing the series of the current document with known series from other documents in that language. Also, a possible relationship of an unknown document to known documents in a database may be determined by comparing the series of n-grams.

One problem with the above known system, however, is that the characterizing of documents on the basis of the series of n-grams has only a limited distinctive power.

### SUMMARY OF THE INVENTION

An object of the invention, inter alia, is to provide a system with which a better distinction can be made between documents.

Another object of the invention is to provide a method, system and device for characterizing documents, which overcome the problems and limitations of the related art.

According to a first aspect of the invention, a method for characterizing a document provides steps by which a list of words occurring in the document is determined, a frequency of occurrence is determined for each word in the list, and the series is built up of pairs respectively of one word from the list and the frequency of that word, the series forming a semantic snapshot of the document.

According to a second aspect of the invention, an apparatus for processing documents, includes a module wherein the module is adapted to determine a list of words occurring in the document, to determine a frequency of occurrence for each word in the list, and to build up the series from pairs of respectively one word from the list and the frequency of that word, the series forming a semantic snapshot of the document.

According to another aspect of the invention, there is provided a computer program product embodied on computer readable media, for characterizing a document, the computer program product comprising computer-executable instructions for determining a list of words occurring in the document; determining a frequency of occurrence for each word in the list; and building up the series with pairs, each paid having one word from the list and the frequency of that word, wherein the series forms a semantic snapshot of the document.

The steps according to an embodiment of the invention have, inter alia, the advantage that the semantic snapshot is related to the content and subject of the document. Moreover, in the case of highly similar documents, such as adapted versions of one and the same document, there is a very distinct correspondence between the semantic snapshots. In this way it is possible automatically to obtain clustering and order of large quantities of documents based on the semantic snapshot.

The invention is also based on the realization that the human language can be approached at different levels by automated analyses. The statistical approach in U.S. Pat. No. 5,418,951 is based on an analysis of the occurrence of letter combinations. This analysis provides an indication as to the language and type of document. But, the inventor of the present application has realized that an automated statistical analysis on the higher semantic level of whole words intended in principle for the human reader is possible, and even gives a much better indicator. This indicator, the so-called semantic snapshot, has thus been found to be very suitable both for relating different documents by subject, and for putting closely related documents in order.

In one embodiment of the method according to the invention, the list of words is processed by omitting words shorter than a predetermined length. This has the effect that short words which occur frequently and give little information as to the nature of the document, are omitted from the semantic snapshot. This increases the distinctive power of the semantic snapshot.

In another embodiment of the method according to the invention, the list of words is processed by sorting by at least one of the following criteria: sequence of occurrence, alphabetical sequence, sequence of word length, and sequence of frequency. Among other things, this has the advantage that the comparison with other semantic snapshots becomes simpler. Particularly in the case of sorting by decreasing the word length, it has been found that the long words provide a good characterization of the document. Furthermore, in the case of sorting by increasing the frequency, it has been found that the low frequencies give a good characterization of the document.

In further embodiments of the method according to the invention, the list of words is processed by combining or replacing words based on correcting incorrectly or differently spelled words, on reduction of verbs or nouns to a basic form, on recognition of homonyms, or synonyms, and/or on a database of technical terms, or else the list of words is processed by translating words into another language. This has the advantage that differences between words which do not give any semantic distinction, may be eliminated. In this way the distinctive power of the semantic snapshot is increased significantly.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BREIF DESCRIPTION OF THE DRAWINGS

The invention will be explained in detail hereinafter with reference to FIGS. 1-4 wherein:

FIG. 1 shows an arrangement for determining a semantic snapshot according to an embodiment of the present invention;

FIGS. 2A and 2B illustrate examples of a semantic snapshot according to the present invention;

FIG. 3 shows an architecture for the compilation of a database based on semantic snapshots according to an embodiment of the present invention; and

FIG. 4 illustrates a module for determining a semantic snapshot according to an embodiment of the present invention.

In the Figures, corresponding elements have the same reference numbers.

### DETAILED DESCRIPTION OF THE PREFERRED EMBODIMENTS

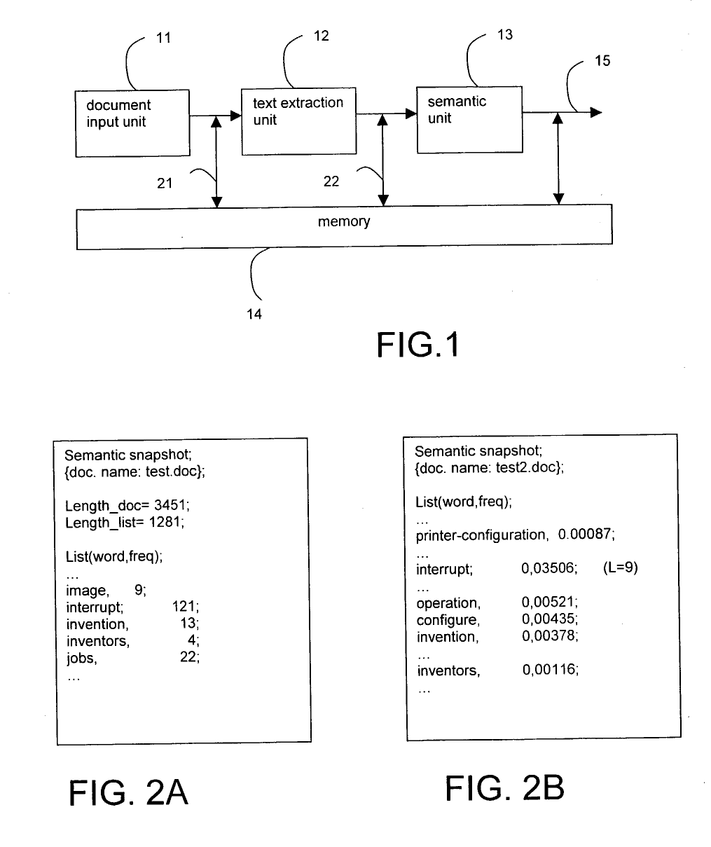

FIG. 1 shows an apparatus for determining a semantic snapshot according to an embodiment of the present invention. As shown, the apparatus comprises a document input unit 11 for inputting documents in electronic form, where an example of the document input unit 11 may be a disk drive for reading document files from a data support such as a floppy disk or CD. The input unit 11 is operatively coupled to a text extraction unit 12 which receives the document from the input unit 11 and in which the text present in the received document is extracted. In this process, the text becomes deprived of layout and form characteristics, such as the font. The result is a plain text version of the document.

The text extraction unit 12 is operatively coupled to a semantic unit 13, and the output of the text extraction unit 12 is input to the semantic unit 13 which determines a series of statistical properties of the extracted text of the document. In this process, first a list of words occurring in the document is determined. Then, a frequency of occurrence is determined for each word in the constructed list by counting the number of times that each word occurs in the text. The word and its frequency together form a pair, referred to herein as a {word, freq}uple. Finally, the statistical series is built up from such pairs of respectively one word from the list and the frequency of that word. The series thus forms a semantic snapshot of the document. A semantic snapshot is a frequency spectrum diagram of the words.

In a subsequent step, the semantic snapshot is used for comparing documents with one another or for comparing with a semantic snapshot of a specific area of attention or subject, so that the relevance of the document for that subject is determined. If both the word list and the frequency diagram of different documents exhibit considerable conformity, then there is a fair chance that the documents are variations of one another. They will (at least) be related in content. With the semantic snapshot, it is possible to form associations between different documents or between different versions of one same document. In the latter case, the frequency diagrams will be very similar to one another, certainly if only minor amendments or additions are involved.

In one embodiment, the list is restricted to words longer than a specific length. As a result, short words having little relevance semantically fall outside the semantic snapshot. Longer words that occur frequently can also be omitted for a better semantic distinctive effect, for example “having” or “being”.

In various embodiments, the semantic unit 13 is arranged for processing the text and/or the list of words and/or the semantic snapshot in the manners described hereinafter. The semantic snapshot is based on the plain text of a document. The quality of the semantic snapshot can be improved by the following techniques. Firstly, different words can be combined or replaced on the basis of semantic relationship. Suitable possibilities are reduction of verbs and/or nouns to their basic form. The combining of words can also be formed by recognizing homonyms or synonyms or by making use of technical term databases.

In the present invention, a semantic snapshot contains a word list and the frequencies of occurrence for each word. The {word, freq}tuples can be sorted in a predetermined manner. Suitable manners for sorting the {word, freq}tuples are, e.g., chronological, namely by the first occurrence of a word in the text, or alphabetically (case sensitive or otherwise). One sorting manner which has good distinctive power is sorting by word length (for example, long words first since these are rarer), or by frequency, rising or falling (low frequencies discriminate better). Different sorting criteria can also be combined, for example first by length and then words of the same length by frequency. Semantic snapshots can be processed or compared with one another more efficiently by these different sorting operations. Another possibility is translating the words in a semantic snapshot, for example from English to Dutch. In this way, documents in different languages can be related. This is a specific advantage of semantic snapshots of documents according to the present invention.

In one embodiment, the semantic snapshot is complemented by the use of known recognizable semantic structures such as author, department, subject, etc. In the case of documents in an existing database, these data can often be derived by the fact that they are stored separately in combination with the document. It is also possible to add previously allocated keywords or other characteristics to the semantic snapshot, or they can be used to control the processing of the word list, e.g. by the use of a relevant database of technical terms and conventional synonyms in that technical area.

In one embodiment, the frequency of occurrence is converted by standardization. In principle, the frequency is a whole number that indicates the absolute number, but it can be normalized by division by the total number of words. In this normalization, information concerning the length of the document may be lost. But, for most types of comparison, this does not have an adverse effect. The length of the document can also be added separately as a parameter to the semantic snapshot.

FIG. 2A shows a first example of a semantic snapshot according to an embodiment of the present invention. This is a data structure containing a series of word +frequency pairs, indicated here by ‘List_word, freq)’. The list is sorted by the alphabetical order. In this example, the following elements have also been added: the name of the original document ‘{doc.name:test.doc}’, the length of the document ‘Length_doc’, and the length of the word list ‘Length_list’.

FIG. 2B shows a second example of a semantic snapshot according to an embodiment of the present invention. As shown in FIG. 2B, the semantic snapshot has now been sorted by the length of words, and then by frequency. In the list, a very long word (‘printer-configuration’) is shown with the word length equal to 21. Some words (e.g., interrupt, operation, etc.) with length L=9 are also shown. The values for the frequencies for the words are given in percentages by normalization using the length of the document.

The semantic snapshot according to the present invention can be kept on a data support with the document, for example on a hard disk or CD-R. If the document is adapted and given a new date, then a semantic snapshot has to be re-determined. It is also possible to store or send the semantic snapshot as a separate data signal, for example via the Internet, extranet, intranet, or other network. In this way a receiver can on the basis of a limited quantity of data determine whether a relevant document is present at the source. It is also possible to limit the quantity of data for the semantic snapshot by using a predetermined “dictionary” of words, and allocating each word therein a code, for example a serial number. The semantic snapshot then is composed of a list of pairs of respectively a word code and the corresponding word frequency. If required, word codes can be used for just part of the list, while words occurring less frequently are completely included in the semantic snapshot.

The semantic snapshot according to the present invention can be used in numerous areas. For example, many reports are collected in a database. Conventionally, these reports were encoded by hand by expensive professionals where the object of the encoding was to group related reports. But, with the semantic snapshot of the present invention, related documents can automatically be clustered together.

Another use of the semantic snap shot involves plagiarism. In this example, a semantic snapshot is made of books, web documents or other documents. If these resemble one another greatly, there may be a case of plagiarism. If they clearly do not resemble one another, then there is no case of plagiarism.

Also, a frequently occurring problem is version management, i.e., possibly different versions of unknown sequence may exist for a document. By determining the semantic snapshot of the documents and their mutual distances, or alternatively the distance from the average document according to the present invention, it is possible to estimate what the version sequence of the documents is. In this connection, a document in handwritten form can also be recognized as an equivalent of the same document in the typed form.

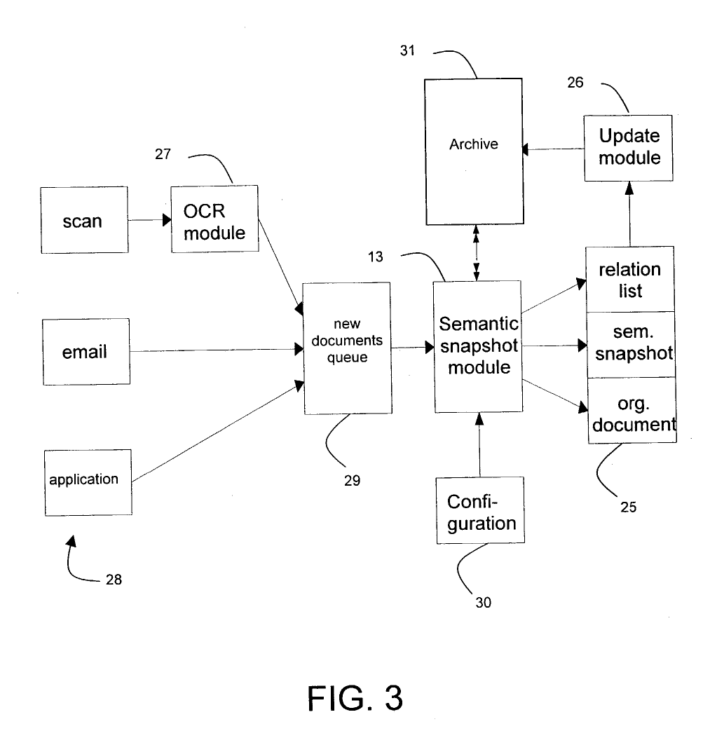

FIG. 3 shows an architecture for building up a database on the basis of semantic snapshots according to an embodiment of the present invention. The method(s) of the present invention can be implemented into the system of FIG. 3 or other suitable systems. Firstly, document sources 28 are indicated with modules such as ‘application’ wherein an application program delivers a document, or alternatively e-mail, or alternatively a scanner for optically scanning a document on paper or other support medium. If the document is supplied in bitmap form, as is the case by a scanner, the document is routed to an OCR module 27 (Optical Character Recognition module) for conversion to a readable text. Obviously, documents or the like may be received using other means and/or in other forms.

All the incoming documents are stored (temporarily) in a memory 29 in which the ‘new documents queue’ is present. Each document is then routed to a semantic snapshot module (or semantic unit) 13 in which the semantic snapshot is determined, for example as described above in connection with FIG. 1. The configuration from a configuration unit 30 is used in determining the semantic snapshot, such as the sorting sequence or the synonyms used, and the configuration is fixed in the configuration unit 30 coupled to the semantic unit 13.

After the semantic snapshot has been determined, it can be stored in a database memory 25 in which, for example, the original document (or a reference thereto), the calculated semantics snapshot and a possible list with relationships to other documents are stored, for example in separate sections as shown. The semantic module 13 is also coupled to an archive 31 in which the data from other documents are stored for comparison with the current document. The archive 31 is regularly updated with the newly processed documents via an update module 26. In the updating process, the relation list of the new document is read, and the semantic snapshot and the other relationships in the archive 31 are adapted thereto.

One practical implementation of the described architecture is a digital copier and/or scanner coupled to a computer system, e.g. via a local area network. In the computer system, the database and the archive of documents present in a company are maintained. If a document is entered for copying or scanning in the machine, a bitmap is prepared and (after an OCR intermediate step) the text is extracted therefrom. The semantic snapshot is then calculated according to the present invention. The module for this function can be incorporated in the digital copier and/or scanner, or else this function can be performed by a software program in the computer or computer system.

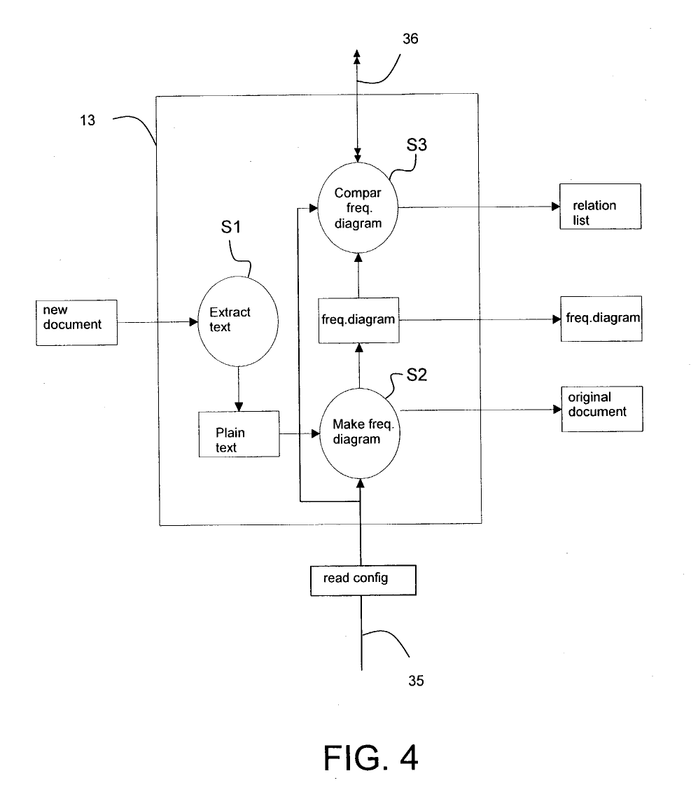

FIG. 4 shows a module for determining a semantic snapshot according to an embodiment of the present invention. This module corresponds to the semantic unit 13 in FIG. 3. It is constructed as a processor with instructions for the operations indicated hereinafter, for example a standard computer with a software program or a specifically (partly hard-) programmed processor. The action of the module is as follows. In a first “extract text” step S1, the plain text is isolated from a new document received to obtain the plan text of the current document. In a second ‘make freq. diagram’ step S2, a word list and the associated frequencies are determined as discussed above. The parameters used in this step are set via the ‘read config’ input 35. These parameters relate, for example, to the minimum word length, a limitation of the frequency, and/or options such as translation and/or the use of specific lists with synonyms or technical terms. As a result of the step S2, the semantic snapshot is determined and available via the ‘freq. diagram’ output, and the original document and/or the plain text version is available via the ‘original document’ output as shown in FIG. 4. The plain text is only required temporarily and if necessary can be re-extracted from the original document.

In one embodiment, the semantic module 13 is provided with a third step S3 ‘compare freq.diagrams’ for comparing the semantic snapshot of the new document with known semantic snapshots. To this end, the semantic module 13 is provided with a data bus 36 for receiving the known semantic snapshots from a source. As a result of the comparison at step S3, a list of relations with other documents or known subjects is available and output as the ‘relation list’ output. In the comparison step S3, the corresponding words in the two semantic snapshots may be first determined and then the associated frequencies may be compared. The differences or correspondences in frequency found can be allocated a weighting, for example in dependence on the location in the sorted list. In this way, a relationship index is calculated for the entire document.

Although the invention has been described hereinbefore with reference to a number of exemplified embodiments, the invention is not limited thereto. The invention comprises any new characteristic or combination of characteristics indicated hereinbefore. For example, the invention can also be constructed as a unit for determining the semantic snapshot of documents already present in a storage system or already having a convenient characterization. The semantic snapshot can then be used to apply a more detailed clustering. It should also be noted that the word “comprise” does not preclude the presence of elements or steps other than those mentioned, that the word “one” does not exclude a plurality, that the reference numbers do not limit the claims, that the invention can be performed both (partly) in hardware and (partly) in software, and that different means or functions can be embodied by the same hardware or software element.

The processing steps of the present invention are implementable using existing computer programming language. As discussed above, such computer program(s) may be stored in memories such as RAM, ROM, PROM, etc. associated with computers. Alternatively, such computer program(s) may be stored in a different storage medium such as a magnetic disc, optical disc, magneto-optical disc, etc. Such computer program(s) may also take the form of a signal propagating across the Internet, extranet, intranet or other network and arriving at the destination device for storage and implementation. The computer programs are readable using a known computer or computer-based device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of characterizing a document wherein a series of statistical properties of text in the document is determined, the method comprising:
determining a list of words occurring in the document;
determining a frequency of occurrence for each word in the list; and
building up the series with pairs, each pair having one word from the list and the frequency of that word,
wherein the series forms a semantic snapshot of the document.

2. A method according to claim 1, wherein, in the step of determining the list of words, the list of words is processed by omitting words shorter than a predetermined length.

3. A method according to claim 1, wherein, in the step of determining the list of words, the list of words is processed by sorting by at least one of the following criteria:
sequence of occurrence;
alphabetical sequence;
sequence of word length; and
sequence of frequency.

4. A method according to claim 1, wherein, in the step of determining the list of words, the list of words is processed by combining or replacing words based on correcting incorrectly or differently spelled words, on reduction of verbs or nouns to a basic form, on recognition of homonyms or synonyms, and/or on a database of technical terms.

5. A method according to claim 1, wherein, in the step of determining the list of words, the list of words is processed by translating words into another language.

6. A method according to claim 1, wherein, in the building step, the semantic snapshot is processed by normalizing the frequencies in the pairs.

7. A method according to claim 1, wherein, in the building step, the semantic snapshot is processed by adding data concerning a semantic structure.

8. A method according to claim 7, wherein the data concerning the semantic structure include author, department, keywords and/or subject.

9. A method according to claim 1, further comprising:
determining a relationship between the document and other documents by comparing semantic snapshots, so as to group related documents by subject or to arrange closely related documents.

10. A method according to claim 1, further comprising:
determining a relationship between the document and a specific subject by comparing the semantic snapshot of the document and a semantic snapshot specific to the subject and on the basis of a set of known documents and/or a list of words relating to the subject.

11. A method according to claim 1, wherein the document is a document delivered by an application program, an e-mail, or a document scanned by a scanner.

12. A method according to claim 1, further comprising:
transmitting the semantic snapshot of the document over a network.

13. A computer program product embodied on at least one computer-readable medium, for characterizing a document, the computer program product comprising computer-executable instructions for:
determining a list of words occurring in the document;
determining a frequency of occurrence for each word in the list; and
building up the series with pairs, each pair having one word from the list and the frequency of that word,
wherein the series forms a semantic snapshot of the document.

14. A computer program product according to claim 13, wherein the list of words is processed by omitting words shorter than a predetermined length.

15. A computer program product according to claim 13, wherein the list of words is processed by sorting by at least one of the following criteria:
sequence of occurrence;
alphabetical sequence;
sequence of word length; and
sequence of frequency.

16. A computer program product according to claim 13, wherein the list of words is processed by combining or replacing words based on correcting incorrectly or differently spelled words, on reduction of verbs or nouns to a basic form, on recognition of homonyms or synonyms, and/or on a database of technical terms.

17. A computer program product according to claim 13, wherein the list of words is processed by translating words into another language.

18. A data signal, wherein the signal represents a data structure of a semantic snapshot as formed by:
determining a list of words occurring in a document;
determining a frequency of occurrence for each word in the list; and
building up a series of statistical properties of text in the document with pairs, each pair having one word from the list and the frequency of the word,
wherein the series forms the semantic snap shop of the document.

19. A data signal according to claim 18, wherein the signal is stored on a data support.

20. An apparatus for processing documents, the apparatus comprising:
a module for characterizing a document by using a series of statistical properties of text of the document,
wherein the module determines a list of words occurring in the document, determines a frequency of occurrence for each word in the list, and builds up the series from pairs, each pair having one word from the list and the frequency of that word,
wherein the series forms a semantic snapshot of the document.

21. An apparatus according to claim 20, further comprising:
a document input unit to extract the text.

22. An apparatus of claim 20, wherein the module processes the list of words by omitting words shorter than a predetermined length.

23. An apparatus of claim 20, wherein the module processes the list of words by sorting by at least one of the following criteria:
sequence of occurrence;
alphabetical sequence;
sequence of word length; and
sequence of frequency.

24. An apparatus of claim 20, wherein the module processes the list of words by combining or replacing words based on correcting incorrectly or differently spelled words, on reduction of verbs or nouns to a basic form, on recognition of homonyms or synonyms, and/or on a database of technical terms.

25. An apparatus of claim 20, wherein the module processes the list of words by translating words into another language.

26. An apparatus of claim 20, wherein the module processes the semantic snapshot by normalizing the frequencies in the pairs.

27. An apparatus of claim 20, wherein the module processes the semantic snapshot by adding data concerning a semantic structure.

28. An apparatus of claim 20, further comprising:
means for determining a relationship between the document and other documents by comparing semantic snapshots, so as to group related documents by subject or to arrange closely related documents.

29. An apparatus of claim 20, further comprising:
means for determining a relationship between the document and a specific subject by comparing the semantic snapshot of the document and a semantic snapshot specific to the subject and on the basis of a set of known documents and/or a list of words relating to the subject.
